(19) United States
(12) Patent Application Publication
(10) Pub. No.: US 2017/0051157 A1
(43) Pub. Date: Feb. 23, 2017

(54) FUNCTIONAL SELF-HEALING COATINGS AND COMPOSITIONS AND METHODS FOR FORMING SUCH COATINGS

(71) Applicant: Chevron U.S.A. Inc., San Ramon, CA (US)

(72) Inventors: Benjamin M. Chaloner-Gill, Alameda, CA (US); Seth T. Taylor, Fullerton, CA (US)

(21) Appl. No.: 15/237,736

(22) Filed: Aug. 16, 2016

Related U.S. Application Data
(60) Provisional application No. 62/208,066, filed on Aug. 21, 2015.

(51) Int. Cl. C09D 5/08; C09D 167/02; C09D 183/04; C09D 175/04; C09D 177/00; B05D 1/28; C09D 125/06; C09D 133/04; C09D 133/14; C09D 5/03; B05D 1/02; C09D 163/00; C09D 123/12

(52) U.S. Cl. CPC C09D 5/084; C09D 163/00; C09D 167/02; C09D 183/04; C09D 175/04; C09D 177/00; C09D 123/12; C09D 125/06; C09D 133/04; C09D 133/14; C09D 5/03; B05D 1/02; B05D 1/28

(57) ABSTRACT

Disclosed are coating compositions, methods for preparing the coatings and coatings made therefrom. The coatings have durable functional and damage healing properties. In some embodiments, compositions include a liquid media, surface modified diatomaceous earth (SMDE) particles chemically modified to impart a desired fluid wettability suspended in the liquid media, and microcapsules suspended in the liquid media. The SMDE particles are chemically modified through the use of various silanes imparting hydrophobicity, hydrophilicity, oleophobicity, or oleophilicity. In certain embodiments, the SMDE particles and the microcapsules are in different coating layers. In certain embodiments, compositions are in the form of powder coatings including mixtures of powder epoxy particles, SMDE particles chemically modified to impart a desired fluid wettability, and microcapsules. Disclosed further are methods for coating articles with the coatings and the coated articles.

### FIELD

The present disclosure relates to coating compositions and functional coatings made therefrom, particularly coating compositions and coatings providing both a desired fluid wettability and damage healing ability. The present disclosure also relates to methods for preparing the coatings, methods for protecting an article with the coatings and the coated article.

### BACKGROUND

Coatings are frequently used to impart barrier protection and/or surface functionality to an underlying substrate. Coatings providing barrier protection, also referred to herein as barrier coatings or protective coatings, are used extensively within various industries for safeguarding an underlying substrate against adverse conditions including corrosion, erosion, environment and wear. Coatings providing surface functionality, also referred to herein as functional coatings, typically impart performance beyond the capabilities of the underlying substrate material. For example, functional coatings are used to impart desired surface energy, adhesion, corrosion resistance, wear resistance and the like. Such functional coatings can be used to provide functionality including drag reduction, engineered wettability in which liquid-solid contact angles are tailored for specific, desired wetting behavior, fouling reduction, fouling release and self-cleaning capabilities. Other functionalities desired in a functional coating can include, but are not limited to, adhesion, reflectivity, anti-reflectivity, UV absorbance, catalytic efficacy, antimicrobial, magnetism, and electrical conductivity. Industrial uses for functional coatings continue to emerge with improved additives and manufacturing processes.

Corrosion of metal surfaces can be mitigated by the application of a barrier coating to prevent exposure of the metal surface to corrosive species in the surrounding environment. Conventional barrier coatings rely on the use of a solid barrier to prevent the passage of moisture and other corrosive species through the coating to the substrate beneath the coating. Polymer-based coatings can fail as a result of thermal or mechanical damage caused suddenly or gradually over time. The failure of such a coating results in the undesirable exposure of the underlying substrate to the environment. Once exposed, the substrate can be susceptible to degradation by corrosion, oftentimes in concert with other damage mechanisms. The failure of barrier coatings necessitates costly repairs or replacements in addition to the decommissioning of parts, equipment or facilities relying on these coatings while maintenance is performed.

Damage repair, also known as self-healing, refers to the ability of a coating to repair thermal or mechanical damage to the coating. Such thermal or mechanical damage can include micro-cracking and scratching, which can ultimately lead to compromised barrier performance and coating delamination. Having the ability to self-heal or self-repair is highly advantageous for a functional coating to mitigate the kinds of damage that commonly cause coating degradation, and therefore improve coating lifetime and reduce total lifecycle costs for coated articles.

There remains a need for a more durable coating for protecting a surface and providing functionality to a surface that would have the ability to repair damage to the coating.

### SUMMARY

In one aspect, a coating composition is provided that is capable of forming a coating having a desired fluid wettability and damage healing ability. The composition includes a liquid media comprising a liquid, surface modified diatomaceous earth particles chemically modified to impart the desired fluid wettability suspended in the liquid media, and microcapsules suspended in the liquid media.

In another aspect, a coating is provided that has a desired fluid wettability and damage healing ability. The coating includes a liquid-applied matrix formed by drying or curing a liquid, surface modified diatomaceous earth particles suspended in the matrix, and microcapsules suspended in the matrix.

In another aspect, a method for preparing a coating composition is provided. The method includes combining a liquid, a plurality of surface modified diatomaceous earth particles and a plurality of microcapsules to form a suspension of the surface modified diatomaceous earth particles and the microcapsules in the liquid.

In another aspect, a coated article is provided that includes a first layer having microcapsules suspended in a liquid-applied matrix on a surface of an article, and a second layer having surface modified diatomaceous earth particles suspended in a liquid-applied matrix on the first layer.

In another aspect, a powder coating composition is provided that is capable of forming a coating having a desired fluid wettability and damage healing ability. The powder coating composition can include a mixture of a plurality of powder epoxy particles, a plurality of surface modified diatomaceous earth particles and a plurality of microcapsules. The powder coating composition can include a plurality of composite particles wherein each composite particle includes a powder epoxy component, a surface modified diatomaceous earth component and a microcapsule component.

### DESCRIPTION OF THE DRAWINGS

These and other objects, features and advantages of the present invention will become better understood with reference to the following description, appended claims and accompanying drawings where:

FIG. 1 is a simplified cross-sectional view of a surface of an article having a layer thereon of a functional, self-healing coating thereon according to one exemplary embodiment.

FIG. 2 is a simplified cross-sectional view of a surface of an article having a functional coating layer and a self-healing coating layer thereon according to another exemplary embodiment.

### DETAILED DESCRIPTION

In one embodiment, a coating composition is provided that is capable of forming a coating having a desired fluid wettability and damage healing ability. The coating composition is in the form of a liquid media having a plurality of surface modified diatomaceous earth (SMDE) particles and a plurality of microcapsules suspended in the liquid media. The coating composition is formed by combining the liquid media, the SMDE particles and the microcapsules to form a suspension.

Diatomaceous earth (DE), also commonly referred to as diatomite and kieselguhr, consists of fossilized skeletal remains of aquatic organisms known as diatoms. Chemically, DE is largely made up of silica. DE is naturally occurring, and is used in a wide variety of products. DE particle sizes can range from submicron to greater than 1 mm in diameter, typically from 10 to 200 μm. DE particles include many submicron pores therein. DE particles generally have a specific gravity from about 2.0 to 2.3. SMDE particles are formed by chemically modifying DE particles to impart a desired fluid wettability to the DE particles and to coatings made therefrom. Suitable diatomaceous earth particles for use in the coating composition of the present disclosure include DE particles having little or no organic contamination. The DE can be natural-grade DE where organic impurities have been removed. The DE particles can have undergone a moderate heat treatment, i.e., less than 800° C., to remove organic contamination and moisture. Such particles are described in U.S. Pat. No. 7,258,731, U.S. Pat. No. 8,216,674 (Simpson et al. '674), U.S. Pat. No. 8,497,021, U.S. Patent Application Publication No. 2008/0286556 A1 and U.S. Patent Application Publication No. 2010/0286582 A1 (Simpson et al. '582), the contents of which are herein incorporated by reference. The DE particles can have a tubular, spherical or disc shape. Simpson et al. '674 and Simpson et al. '582 disclose a superhydrophobic powder prepared by surface modifying natural-grade DE particles with a hydrophobic silane moiety on the particle surface such that the coating conforms to the topography of the DE particles. The surface modification can be a self-assembly monolayer of a perfluorinated silane coupling agent. Self-assembled monolayers (SAMs) are single layers of molecules on a substrate where a head group of the molecule is directed to a surface, generally by the formation of at least one covalent bond, and a tail group is directed to the air interface to provide desired surface properties, such as hydrophobicity or hydrophilicity. A non-exclusive list of exemplary SAM precursors that can be used for various embodiments is disclosed in Simpson et al. '582.

The DE particles are chemically modified to achieve the desired fluid wettability of the coating. The DE particles can be chemically modified by any known method that would result in a desired modification of the fluid wettability of the coating while maintaining porosity. In one embodiment, the DE particles are modified by a silane, preferably a functionalized silane, e.g., an organofunctional alkoxysilane. The thus chemically modified diatomaceous earth particles, also referred to as surface modified diatomaceous earth or SMDE particles, have a layer containing the functionalized silane conforming to the surfaces of the DE particles. Organofunctional alkoxysilanes suitable as the functionalized silane can include aminosilanes having an amine organic function, glycidoxysilanes having an epoxide organic function and mercaptosilanes having a thiol organic function.

In some embodiments, it is desired to increase the hydrophobicity of the coating, for example when self-cleaning, antifouling, reduced drag, water repellency, anti-icing and the like are desired surface properties. In such embodiments, a hydrophobic silane can be used to treat the DE particles. For example, such hydrophobic silanes can include, but are not limited to, methyltrichlorosilane, dimethyldichlorosilane, trimethylchlorosilane, their alkoxy derivatives, hexamethyldisilazane, and propyl-, isobutyl- or octyltrialkoxysilanes.

In some embodiments, it is desired to increase the hydrophilicity of the coating. For example, increased hydrophilicity can be desired when drag resistance, self-cleaning (caused by forming water sheeting), anti-fogging, biocompatibility and the like are desired surface properties. In such embodiments, a hydrophilic silane can be used to treat the DE particles. For example, such hydrophilic silane can include, but is not limited to, a polar aprotic silane.

In some embodiments, it is desired to increase the oleophobicity of the coating. For example, increased oleophobicity can be desired when anti-fouling, self-cleaning, anti-smudge, low-drag, anti-fog, oil-water separation and the like are desired surface properties. In such embodiments, an oleophobic silane can be used to treat the DE particles. For example, such an oleophobic silane can include, but is not limited to, a perfluoroalkoxysilane, e.g., heptadecafluoro-1,1,2,2-tetrahydrodecyl)trimethoxysilane.

In some embodiments, it is desired to increase the oleophilicity of the coating, for example, in oil-water separation applications. In such embodiments, an oleophilic silane can be used to treat the DE particles. For example, such oleophilic silanes can include, but are not limited to, carboxyphenylsilane, allylsilane, vinylsilane, vinyltriethoxysilane, vinyl-tris (beta methoxyethoxy)silane, gamma-glycidoxypropyltrimethoxysilane, beta-(3,4 epoxycyclohexyl)-ethyltrimethoxysilane, and the like.

In some embodiments, the modification of the DE particles can include the deposition of an intermediate layer that will chemically bond, or otherwise adhere, to the DE surface; conform to the DE topography; and bond to the functionalized silane applied to the intermediate layer. Generally, it is preferred to practice the invention without an intermediate layer because the deposition of two conformal coatings increases the complexity and will generally increase the cost of the deposition process.

Example of suitable microcapsules, also referred to as microencapsulated healing agents, are disclosed in U.S. Pat. No. 6,858,659 (White et al. '659), U.S. Pat. No. 6,518,330 (White et al. '330), U.S. Pat. No. 7,566,747, U.S. Pat. No. 7,569,625, U.S. Pat. No. 7,612,152, U.S. Pat. No. 7,723,405, U.S. Pat. No. 8,383,697, U.S. Pat. No. 8,951,639 and U.S. Pat. Pub. No. 2014/0371362 A1 (Wilson), the contents of which are herein incorporated by reference. White et al. '659 and White et al. '330 disclose a self-healing composite material containing a polymer, a polymerizer, a corresponding catalyst for the polymerizer and a plurality of capsules. The polymerizer is contained in the capsules. Wilson discloses self-healing materials which are capable of repairing themselves without any external intervention when they are damaged. The self-healing materials may be microencapsulated in the form of a single type of capsule. Thermal or mechanical damage to a coating containing the microcapsules may rupture the microcapsules and cause the healing materials to be released into the site of damage, where it may polymerize and restore the functional capabilities of the coating. The self-healing materials may be based on unsaturated multi-functional resins capable of oxygen-initiated cross-linking, and may include alkyd resins, such as alkyd resins that include one or more telechelic end groups. As disclosed in Wilson, the alkyd resins can be synthesized from linoleic acid and phthalic anhydride. Suitable self-healing materials may take advantage of the ability of unsaturated functional groups, such as those present in fatty acids, to cross-link in the presence of oxygen. For example, a tri-functional alcohol, such as glycerol, may undergo an esterification reaction with an acid that, in turn, contains a functionality, such as anhydride functionality, that is capable of polymerization to form a resin. In various embodiments, this may create a bi-functional resin that can be encapsulated in a healing agent formulation for release to a damage site. Once released at the site of damage, the unsaturated functional groups may cross-link in the presence of oxygen to yield a polymer that heals the damage to the coating.

In embodiments in which a single type of capsule is provided as the microcapsule, a healing material comprising a resin, such as an alkyd resin, may be formulated, wherein both a non-polar solvent and a polar solvent may be encapsulated together in a microcapsule. The polar solvent may have a range of properties that renders it suitable for encapsulation and stabilization of the resin to prevent premature cross-linking of the resin. When the microcapsule is ruptured as a result of damage, it may then release the healing agent into the site of damage where the solvents (both polar and non-polar) evaporate, allowing cross-linking to be initiated by the uptake of oxygen from the environment.

In some embodiments, the resin contained within the microcapsules is an epoxy. In one embodiment, upon damage to the coating, the epoxy-containing microcapsules are ruptured, releasing the epoxy. The epoxy can then contact a residual curing agent present in the matrix thus initiating cross-linking. The cross-linked epoxy heals the damage to the coating. In another embodiment, a curing agent is provided in a second plurality of microcapsules. Upon damage to the coating, both the epoxy-containing and the curing agent-containing microcapsules are ruptured, resulting in release of the epoxy and the curing agent and consequently cross-linking. The epoxy-containing microcapsules and the curing agent-containing microcapsules can be provided in a range from about 5% to about 10% by weight.

In other embodiments, the coating can contain silicone-containing microcapsules and curing agent-containing microcapsules. Again, upon damage to the coating, both the silicone-containing and the curing agent-containing microcapsules are ruptured, resulting in release of the silicone and the curing agent and consequently cross-linking between the silicone and the curing agent. The silicone-microcapsules and the curing agent-containing microcapsules can be provided in a range from about 5% to about 10% by weight.

Self-healing performance may be improved and thereby the concentration of the microencapsulated self-healing additive may be lowered by taking advantage of telechelic groups in the resin. In some embodiments, functional group matching may be used with an alkyd resin with telechelic epoxy functional groups. For instance, when a self-healing material is formulated as described above, and a resin is released into the site of damage following damage to the coating, the epoxy group will cross-link with residual epoxy groups and epoxy curing agents present in the surrounding liquid-applied matrix. The result is a polymerized healing agent that is covalently bonded to the matrix. This improved adhesion to the matrix may lead to improved self-healing performance at lower concentrations of the healing agent. An alkyd resin with telechelic epoxy functional groups can be used. Other embodiments may use an alkyd resin that includes telechelic end groups that may cross-link with other complementary residual reactive groups such as isocyanates, polyols, vinyl-terminated silanes, vinyl and other unsaturated groups. Likewise, adhesion to the liquid-applied matrix of adjacent layers can also be improved.

In another embodiment, the self-healing materials may be microencapsulated in the form of two distinct types of capsule. In this embodiment, the coating includes the above-described microcapsules and further includes a second type of capsule containing a catalyst to increase the rate of cross-linking. The second type of capsule can be a metallic salt or complex, which is commonly referred to as a drier when the resin or monomer is an alkyd. Examples of metal complexes that can be used either by themselves or in combination with others include primary driers based on cobalt, manganese, iron, cerium, and vanadium. These driers can be used in concert with secondary driers based on zirconium, bismuth, barium, and aluminum complexes and or auxiliary driers based on calcium, zinc, lithium and potassium complexes, to name a few examples. For facile mixing of healing agents released into the site of damage, in various embodiments, the non-polar solvent in the capsule containing the resin may be used as the medium for delivery of the catalyst.

The second type of capsule can further include a curing agent for the telechelic group in addition to a catalyst for the cross-linking of the unsaturated groups.

The healing agents of the microcapsules are encapsulated in polymeric shell walls. In various embodiments, various shell walls can be used for the compartmentalization of healing agents including urea-formaldehyde, polyurethane, and combinations of the two. Resulting microcapsules may be incorporated into a formulation in a wet final form (such as a slurry or wet cake), which might contain moisture at 15 wt % and greater or in a dry final form, which typically contains moisture at 2 wt % or less. All microcapsules may be produced at a particle size of 1 micrometer or greater, but in various embodiments, particle size may be from 5 to 100 micrometers.

The SMDE particles and the microcapsules can be applied as a suspension in a binder solution, also referred to as a liquid media, to a substrate to produce a coating on the surface of the substrate. Thus the coating composition is prepared by combining the SMDE particles and the microcapsules in the liquid media. The coating composition can utilize any suitable liquid media. The use of a binder allows attachment of the particles to nearly any surface including glasses, plastics, elastomers, metals, and ceramics. Solvents and other processing aids can be added to the binder to facilitate binding and/or direct the binder to a desired portion of the particles and/or substrates. For example, a hydrophobic DE powder of the invention can be suspended in acetone containing a small amount of a polystyrene or polyacrylate resin as a binder. The polyacrylate can be poly(methylacrylate), poly(ethylacrylate), poly(methylmethacrylate) or any polymerized ester or acrylic acid or substituted acrylic acid. A wide variety of polymers can be used as the binder. For instance, examples of a suitable liquid media, include, but are not limited to, polyurethane, epoxy, polysiloxane, aliphatic polyamide, polypropylene, polystyrene, polyacrylate, cyanoacrylate, amorphous fluoropolymer, acrylic copolymer and alkyd resin mixtures, and combinations thereof The liquid media can include further components, including tackifiers, plasticizers, dispersants and other components typically found in binders.

The liquid coating composition can contain from 2 wt % to 10 wt %, and even from 5 wt % to 10 wt %, microcapsules. The liquid coating composition can contain from 20 wt % to 50 wt %, and even from 25 wt % to 35 wt %, SMDE particles.

In one embodiment, the microcapsules are added to the liquid coating composition after the mixing step involving the highest shear stresses in order to avoid rupturing of the microcapsules during the formation of the coating composition.

The coating composition can be applied to an article as a liquid, by any of a variety of knowing means. For instance, liquid coating composition can be painted onto a substrate by roller or brush. In a preferred embodiment, the liquid coating composition is sprayed onto the substrate. Alternatively, the article to be coated can be dipped in the liquid coating composition. The coating is then dried or cured to form the coating at standard conditions. Drying times may vary depending on temperature and humidity levels. The dried or cured liquid media forms a liquid-applied matrix in which the particles of the water repellent material and the microcapsules are suspended. Upon drying or curing of the liquid media, the coating is adhered to the substrate surface by the liquid-applied matrix, imparting the desired functionality to the substrate.

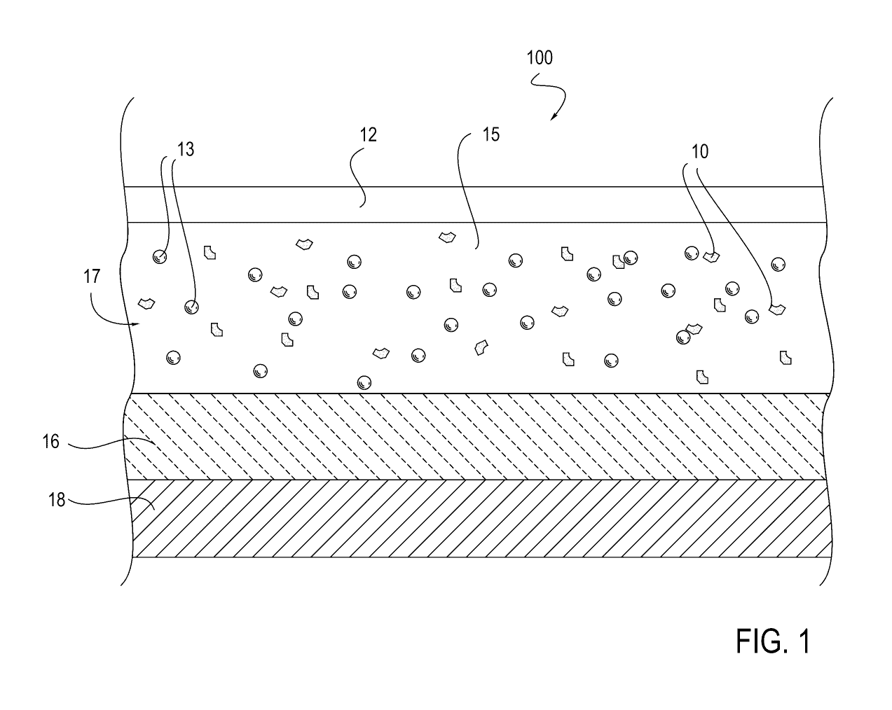

One embodiment of a coated article 100 is shown in FIG. 1. The surface of an article, also referred to herein as a substrate 18, is coated with an optional primer layer 16. Coating layer 17 adjacent either the substrate 18 or the primer layer 16 includes resin-containing microcapsules 13 as described herein suspended in a liquid applied matrix 15 as described herein. Also suspended in the liquid applied matrix 15 are surface modified diatomaceous earth particles 10. As more completely described herein elsewhere, the surface modified diatomaceous earth particles 10 are chemically modified to impart the desired fluid wettability of the coating layer 17. Coating layer 17 is applied as a liquid by any convenient application means. Once applied, coating layer 17 is dried or cured. Coating layer 17 can have a thickness from about 4 to about 8 mils (102 μm to 203 μm). Additional coating layers (not shown) can also be present on the surface of coating layer 17. An optional topcoat 12 can be applied. The topcoat 12 can be formed of any known suitable material, including polyurethane, epoxy, polysiloxane and combinations thereof The optional top coat has a thickness from about 2 to about 4 mils (50 to 102 μm).

Any of the coating layers can further include optional additives as would be apparent to one skilled in the art, including e.g., dyes, pigments, dispersants, emulsifiers, fillers, plasticizers, surfactants, suspending agents, anti-foaming agents, UV absorbers, light stabilizers, and the like.

In one embodiment, by virtue of the presence of the microcapsules, the coating is able to heal mechanical, thermo-mechanical and/or chemical damage to the coating. When the damage occurs, the microcapsules rupture so that the contents thereof are released at the site of the damage. Thus the coatings disclosed herein are self-healing, i.e., capable of repairing themselves without any external intervention when they are damaged.

In one embodiment, a protective coating is provided that is capable of repelling water and healing damage to the protective coating. The protective coating includes a liquid-applied matrix formed by the drying or curing of a liquid, particles of a water repellent material suspended in the matrix, and microcapsules suspended in the matrix.

The protective coating can prevent water from penetrating to the substrate from the exterior while still allowing escape of water vapor from within the protective coating.

A water repellent, corrosion resistant article can be provided by applying the coating composition to the article and thereafter drying or curing the composition.

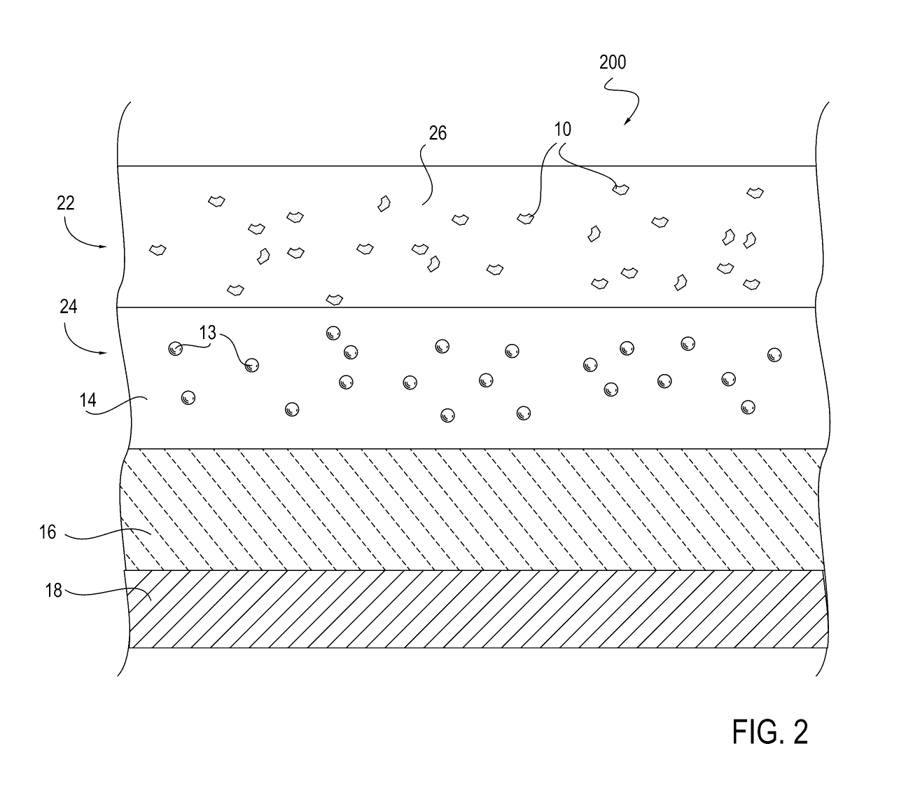

In one embodiment of a coated article 200, as shown in FIG. 2, the article has a substrate 18 onto which an optional primer layer 16 and a first layer 24 is applied. The first layer 24 includes microcapsules 13 suspended in a liquid applied matrix 14. First layer 24 can have a thickness from about 4 to about 8 mils (102 μm to 203 μm). A second layer 22 atop the first layer includes surface modified diatomaceous earth particles 10 suspended in a liquid applied matrix 26. Second layer 22 can also have a thickness from about 4 to about 8 mils (102 μm to 203 μm). Additional layers which include the surface modified diatomaceous earth particles 10 and/or the microcapsules 13 can also be applied. In one embodiment, a water repellent, corrosion resistant article 200 can be prepared by applying a multilayer coating to the surface of an article, wherein the multilayer coating includes at least two different layers 22 and 24, at least one of which is a water repellent layer and at least one of which is a self-healing layer. Any suitable number of coating layers can be used. An optional topcoat (not shown) can be applied. The optional top coat has a thickness from about 2 to about 4 mils (50 to 102 μm). In one embodiment, the coating has three layers and a total thickness from about 9 to about 12 mils (229 to 305 μm).

In one embodiment, the coating composition is in the form of a powder coating. In one embodiment, the powder coating composition is a mixture of powder epoxy particles, SMDE particles, and microcapsules. The mixture can include from about 70 to about 90 wt % powder epoxy particles, from about 5 to about 20 wt % SMDE particles, and from about 5 to about 10 wt % microcapsules. In another embodiment, the powder coating composition includes composite particles, wherein each composite particle contains a powdery proxy component, a SMDE component and a microcapsule component.

In one embodiment, an article can be coated by spraying the powder coating composition onto the article via electrostatic spray deposition (ESD). In ESD, the powder coating is sprayed using an electrostatic gun or corona gun past an electrode to impart a positive charge to the powder coating. The article to be coated is grounded thus attracting the powder coating to its surface. The coating is then cured under heat.

In one embodiment, the coatings disclosed herein can be applied to an article for use in a marine environment. For example, the coatings disclosed herein can be applied to a hull or a body of a marine vessel.

The present disclosure aims to improve the performance and increase the life of a coating, especially two layer and three layer coating systems designed for corrosion protection. Coatings disclosed herein incorporate two separate additives, one that provides a desired fluid wettability, and one that provides the capacity for self-healing of thermal and mechanical damage.

The coatings disclosed herein can be applied to an external surface of an article, an internal surface of an article, or both.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A coating composition capable of forming a coating haying a desired fluid wettability and damage healing ability, comprising:
a. a liquid media comprising a liquid;
b. a plurality of surface modified diatomaceous earth particles chemically modified to impart the desired fluid wettability suspended in the liquid media; and
c. a first plurality of microcapsules containing a resin suspended in the liquid media.

2. The coating composition of claim 1, wherein the plurality of surface modified diatomaceous earth particles is chemically modified with hydrophobic silane.

3. The coating composition of claim 1, wherein the plurality of surface modified diatomaceous earth particles is chemically modified with hydrophilic silane.

4. The coating composition of claim 1, wherein the plurality of surface modified diatomaceous earth particles is chemically modified with oleophobic silane.

5. The coating composition of claim 1, wherein the plurality of surface modified diatomaceous earth particles is chemically modified with oleophillic silane.

6. The coating composition of claim 1, wherein the coating composition comprises from 20 to 50 wt % of the plurality of surface modified diatomaceous earth particles and from 2 to 10 wt % of the first plurality of microcapsules.

7. The coating composition of claim 1, wherein each of the first plurality of microcapsules contains a resin selected from the group consisting of epoxy, alkyd, and combinations thereof.

8. The coating composition of claim 1, further comprising a second plurality of microcapsules containing a curing agent.

9. The coating composition of claim 8, wherein each of the first plurality of microcapsules contains a resin selected from the group consisting of silicone and epoxy.

10. The coating composition of claim 1, wherein the liquid media comprises a liquid selected from the group consisting of polyurethane, epoxy, polysiloxane, aliphatic polyamide, polypropylene, polystyrene, polyacrylate, cyanoacrylate, amorphous fluoropolymer, acrylic copolymer and alkyd resin mixtures, and combinations thereof.

11. A coating haying a desired fluid wettability and damage healing ability, comprising:
a. a liquid-applied matrix formed by drying or curing a liquid;
b. a plurality of surface modified diatomaceous earth particles suspended in the matrix; and
c. a first plurality of microcapsules containing a resin suspended in the matrix.

12. The coating of claim 11, wherein the plurality of surface modified diatomaceous earth particles is chemically modified with hydrophobic silane.

13. The coating of claim 11, wherein the plurality of surface modified diatomaceous earth particles is chemically modified with hydrophilic silane.

14. The coating of claim 11, wherein the plurality of surface modified diatomaceous earth particles is chemically modified with oleophobic silane.

15. The coating of claim 11, wherein the plurality of surface modified diatomaceous earth particles is chemically modified with oleophilic silane.

16. The coating of claim 11, wherein each of the first plurality of microcapsules contains a resin selected from the group consisting of epoxy, alkyd, and combinations thereof.

17. The coating of claim 11, further comprising a second plurality of microcapsules containing a curing agent.

18. The coating of claim 17, wherein each of the first plurality of microcapsules contains a resin selected from the group consisting of silicone and epoxy.

19. The coating of claim 11, wherein the liquid-applied matrix comprises a material selected from the group consisting of polyurethane, epoxy, polysiloxane, aliphatic polyamide, polypropylene, polystyrene, polyacrylate, cyanoacrylate, amorphous fluoropolymer, acrylic copolymer and alkyd resin mixtures, and combinations thereof.

20. The coating of claim 11, wherein upon mechanical and/or thermal damage to the coating, at least one microcapsule of the first plurality of microcapsules is ruptured thereby releasing resin.

21. The coating of claim 11, wherein the coating has a thickness of from about 102 to about 305 μm.

22. A method for preparing a coating composition, comprising combining a liquid, a plurality of surface modified diatomaceous earth particles and a first plurality of microcapsules containing a resin to form a suspension of the plurality of surface modified diatomaceous earth particles and the first plurality of microcapsules in the liquid.

23. The method of claim 22, wherein the plurality of surface modified diatomaceous earth particles is chemically modified with hydrophobic silane.

24. The method of claim 22, wherein the plurality of surface modified diatomaceous earth particles is chemically modified with hydrophilic silane.

25. The method of claim 22, wherein the plurality of surface modified diatomaceous earth particles is chemically modified with oleophobic silane.

26. The method of claim 22, wherein the plurality of surface modified diatomaceous earth particles is chemically modified with oleophilic silane.

27. The method of claim 22, wherein the coating composition comprises from 20 to 50 wt % the plurality of surface modified diatomaceous earth particles and from 2 to 10 wt % the first plurality of microcapsules.

28. The method of claim 22, wherein each of the first plurality of microcapsules contains a resin selected from the group consisting of epoxy, alkyd, and combinations thereof.

29. The method of claim 22, further comprising a second plurality of microcapsules containing a curing agent.

30. The method of claim 29, wherein each of the first plurality of microcapsules contains a resin selected from the group consisting of silicone and epoxy.

31. The method of claim 22, wherein the liquid media comprises a liquid selected from the group consisting of polyurethane, epoxy, polysiloxane, aliphatic polyamide, polypropylene, polystyrene, polyacrylate, cyanoacrylate, amorphous fluoropolymer, acrylic copolymer and alkyd resin mixtures, and combinations thereof.

32. A coated article, comprising an article having a layer thereon comprising the coating of claim 11; wherein the layer has a thickness of from 102 μm to 203 μm.

33. A coated article, comprising:
a. a first layer comprising a first plurality of microcapsules containing a resin suspended in a liquid-applied matrix on a surface of an article; and
b. a second layer comprising a plurality of surface modified diatomaceous earth particles suspended in a liquid-applied matrix on the first layer.

34. A method for coating an article comprising applying at least two layers on the surface of an article wherein the at least two layers include a first layer comprising a first plurality of microcapsules containing a resin suspended in a liquid-applied matrix and a second layer comprising a plurality of surface modified diatomaceous earth particles suspended in a liquid-applied matrix.

35. A powder coating composition capable of forming a coating haying a desired fluid wettability and damage healing ability, comprising a mixture comprising:
a. a plurality of powder epoxy particles;
b. a plurality of surface modified diatomaceous earth particles; and
c. a first plurality of microcapsules containing a resin.

36. The powder coating composition of claim 35, wherein the mixture comprises from about 70 to about 90 wt % powder epoxy particles, from about 5 to about 20 wt % surface modified diatomaceous earth particles, and from about 5 to about 10 wt % microcapsules.
